(19) United States
(12) Patent Application Publication
(10) Pub. No.: US 2016/0284015 A1
(43) Pub. Date: Sep. 29, 2016

(54) Unified System Kernel For Web Based Commerce Over Multiple Product Branches

(71) Applicant: Devin Koskan, Wood, SD (US)

(72) Inventor: Devin Koskan, Wood, SD (US)

(21) Appl. No.: 14/670,713

(22) Filed: Mar. 27, 2015

(51) Int. Cl. G06Q 30/06; G06F 17/30

(52) U.S. Cl. CPC G06Q 30/0641; G06F 17/30864

(57) ABSTRACT

Merchants join a merchant subscriber based system and enjoy inquiries from consumers interested in purchasing goods or services. An automated system requires minimal human resources as a unified system kernel quickly assimilates products and vendors from different product areas. A unified system kernel may automatically set up licensees such that licensees of a disclosed embodiment may enjoy direct sales to consumers. Disclosed embodiments present a turn-key opportunity for licensees or franchisees to enjoy competitive advantages over other sellers of goods and services. Disclosed embodiments may be leased or licensed to merchants interested in selling within different branches of products or services. Disclosed embodiments also include an internal system of points used for currency and other exchange purposes.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever. Such trademarks may include the terms “MYLO”, “MyLo” and others.

### BACKGROUND OF THE INVENTION

(1) Field of the Invention

The invention generally relates to web based systems of commerce. More particularly, the invention relates to the use of machines and methods to efficiently facilitate a centralized clearing house of commerce convenient for both vendors and consumers.

(2) Description of the Related Art

U.S. Pat. No. 8,756,112 issued on Jun. 17, 2014 to Edelman discloses a complex car purchasing system wherein buyer information is reviewed for credit worthiness. Unfortunately, Edelman fails to provide means or methods of allowing multiple vendors from multiple product fields to access customers in an efficient manner. Thus, there is ample room in the art for the present invention.

### BRIEF SUMMARY OF THE INVENTION

The present invention overcomes shortfalls in the related art by presenting an unobvious and unique combination, configuration and use of computer components, machine readable instructions, unified system kernels, and unique methods to provide vendors with a turn-key system that may be purchased, leased or licensed from a system owner.

Disclosed embodiments include a centralized system comprising a unified system kernel and other components and various methods to allow subscribing, leasing or purchasing vendors an opportunity to quickly load in different branches or categories of products. Once a branch or category of products is entered into a disclosed embodiment, the numerous aspects of the branch of product are available monetization.

For example, from the consumer side, a consumer may submit a request for a product or service to central server system. The system may then transmit the request to a plurality of subscribing vendors who may then bid on providing the product or service. The system may then filter vendor bids by consumer defined criteria.

On the vendor side, a vendor may subscribe to various categories of products or services, receive consumer requests as filtered to the vendor's subscribed categories, transmit bids to the server system, and if selected by the biding consumer, make a transaction. In one contemplated embodiment, a vendor pays fees to the system operators only after a transaction is completed.

The presently disclosed embodiments overcome many shortfalls in the prior art. For vendors, shortfalls in the art include the expenses of creating attractive web sites and advertisements for all products stored within a warehouse. In the prior art, such advertisements are needed or created even if consumers are familiar with the product. Such expenses are incurred to get closer to a customer even though sales are not guaranteed. The prior art requires vendors to estimate or calculate marketing and advertising expenses and then make such expenditures based upon projections or guesses of future sales. The presently disclosed embodiments overcome these and other prior art shortfalls by, inter alio, providing vendors a turn-key marketing and customer acquisition system. Operators of a disclosed embodiment may advertise or otherwise market the system and/or products offered within the system.

In one embodiment, a transaction, method or process may occur as follows:

A consumer may interact with the system via a web page, social media or other system interface and submit a request for a product or service. The consumer may be queried for product details. In response, the system will provide a first phase response that may comprise a price range for all matching items. On the machine side, the entire internet and/or other information sources may be reviewed to produce the price ranges of the first phase.

In a second phase, the consumer reviews the price ranges of the first phase and then submits a desired price to pay and optionally desired product attributes.

On the machine side, the consumer desired price submission is transmitted to a number of vendors having the best matches to the consumer request. System selected vendors will receive the consumer request and will be asked for their best price. After vendor prices are received, the system may negotiate shipping, delivery or freight prices to the consumer. The system may also negotiate finance charges and/or insurance rates. The system may optionally engage in automated negotiations in an effort to obtain lower prices or better values to the consumer.

In a next step, a relatively small number of top results are presented to the consumer. In an alternative additional step, corresponding or ancillary goods may be offered to the consumer.

Shortfalls in the related art are overcome as consumers are able to obtain the best available prices without human interaction. Such prices are obtained from the entire universe of sellers. Shortfalls in the related art are overcome as vendors may stop spending money on marketing and advertising and may focus on providing the best customer prices and services.

Disclosed embodiments include a made request dashboard and an observe all requests dashboard. Disclosed embodiments include means and methods of consumers selling their used cars and other items.

### BRIEF DESCRIPTION OF THE DRAWINGS

FIG. 1 is a pseudo screen shot of a purchase interface for a consumer

FIG. 2 is a pseudo screen shot of a product listing function

FIG. 3 is a pseudo screen shot of a “skip that” function

FIG. 4 is a pseudo screen shot of a selection of year function

FIG. 5 is a pseudo screen shot of a desired price slider function

FIG. 6 is a pseudo screen shot of an additional requirement function

FIG. 7 is a pseudo screen shot of a my requests icon

FIG. 8 is a pseudo screen shot of an offered price interface

FIG. 9 is a pseudo screen shot of a selection of top offer interface

FIG. 10 is a pseudo screen shot of an offer accepted interface

FIG. 11 is a pseudo screen shot of an interface for a consumer to sell a product

FIG. 12 is a pseudo screen shot of a product selection interface for product sales by consumers

FIG. 13 is a pseudo screen shot of an additional description interface

FIG. 14 is a pseudo screen shot of a desired price to receive interface

FIG. 15 is a pseudo screen shot of a bid observation interface

FIG. 16 is a pseudo screen shot of a bid acceptance interface

FIG. 17 is a pseudo screen shot of a company or vendor settings interface

FIG. 18 is a pseudo screen shot of an interface to manage incoming requests

FIG. 19 is a pseudo screen shot of a buy requests dashboard

FIG. 20 is a pseudo screen shot of an interface showing recently accepted offers and actions required

FIG. 21 is schematic view of a disclosed machine system

FIG. 22 is a schematic view of a disclosed system architecture and related technology

### REFERENCE NUMERALS IN THE DRAWINGS

100 interface for a consumer to enter type of product desired for purchase

110 interface for a disclosed method of purchase

120 drop down listing of possible matches to entered data

130 skip that function

135 year selection function

140 sliding scale function to select desired price to pay

142 selection of additional product features

144 my request icon

146 offer of sale

148 interface showing offer accepted

150 data entry point or interface to enter a product to sell

152 selection of product categories

154 additional description interface for product to be sold by a consumer

156 slider function to select desired selling price of product sold by a consumer

158 observed bid to purchase a product

160 interface showing that an offer to purchase was accepted

162 interface for vendor or buyer subscriptions

164 selection tree of acceptable incoming product requests

166 buy request interface and display

168 interface and display for action required after an offer is accepted

300 a disclosed database, method and machine system

310 system website or other user interface

320 system mobile applications

330 application programing interface

333 system search engine

335 notification engine

337 system scrapper collection application

340 system order processor engine

343 database system

345 cars.com scrapper or search engine adapter

347 scrapper or search engine database

350 system control and administration panel for system scraper

400 disclosed system attributes

410 public website or interface

413 system of database collection and manipulation

415 collection from database

417 search system

419 loop of search and storage

421 system of search

423 system of search on the vendor side

425 system of search on the system side

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

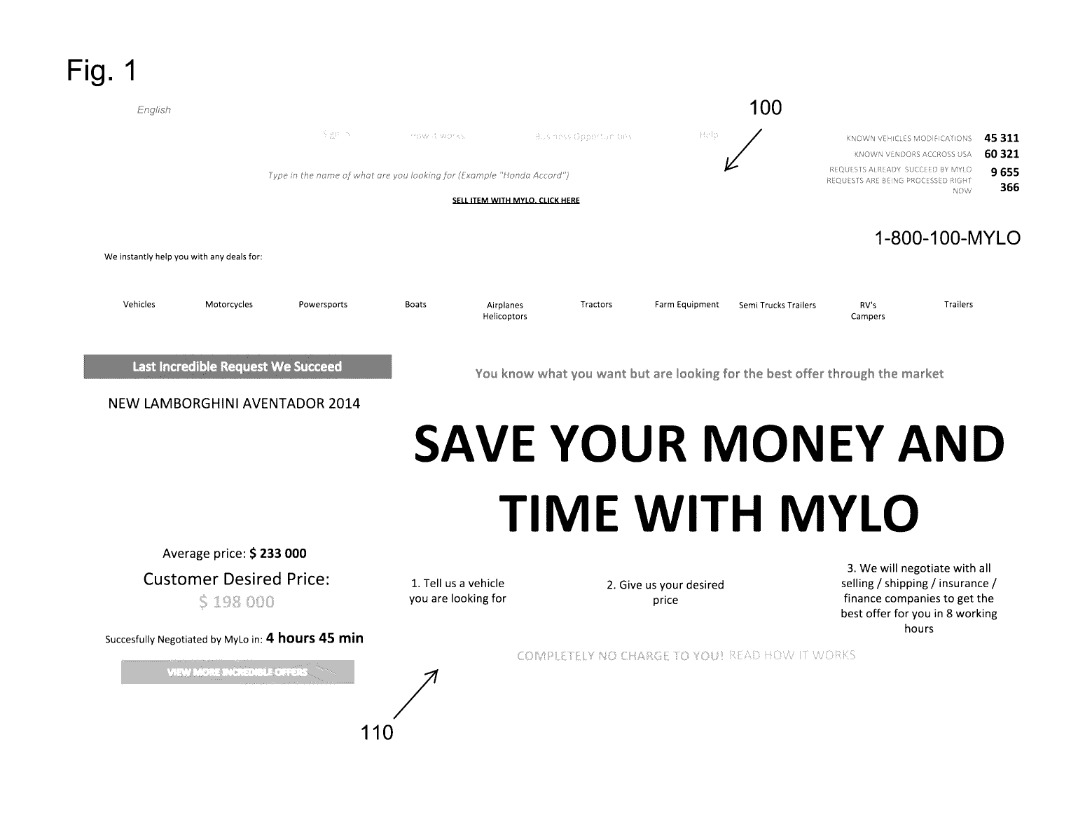

Referring to FIG. 1, a home page or start page is depicted and defines an interface 100 for a consumer to enter type of product desired for purchase. Below the product entry interface is an interface 110 displaying a disclosed method of purchase. A general purpose of the start page and/or first interface 100 is to allow consumers an ability to select or find products to purchase through a disclosed embodiment.

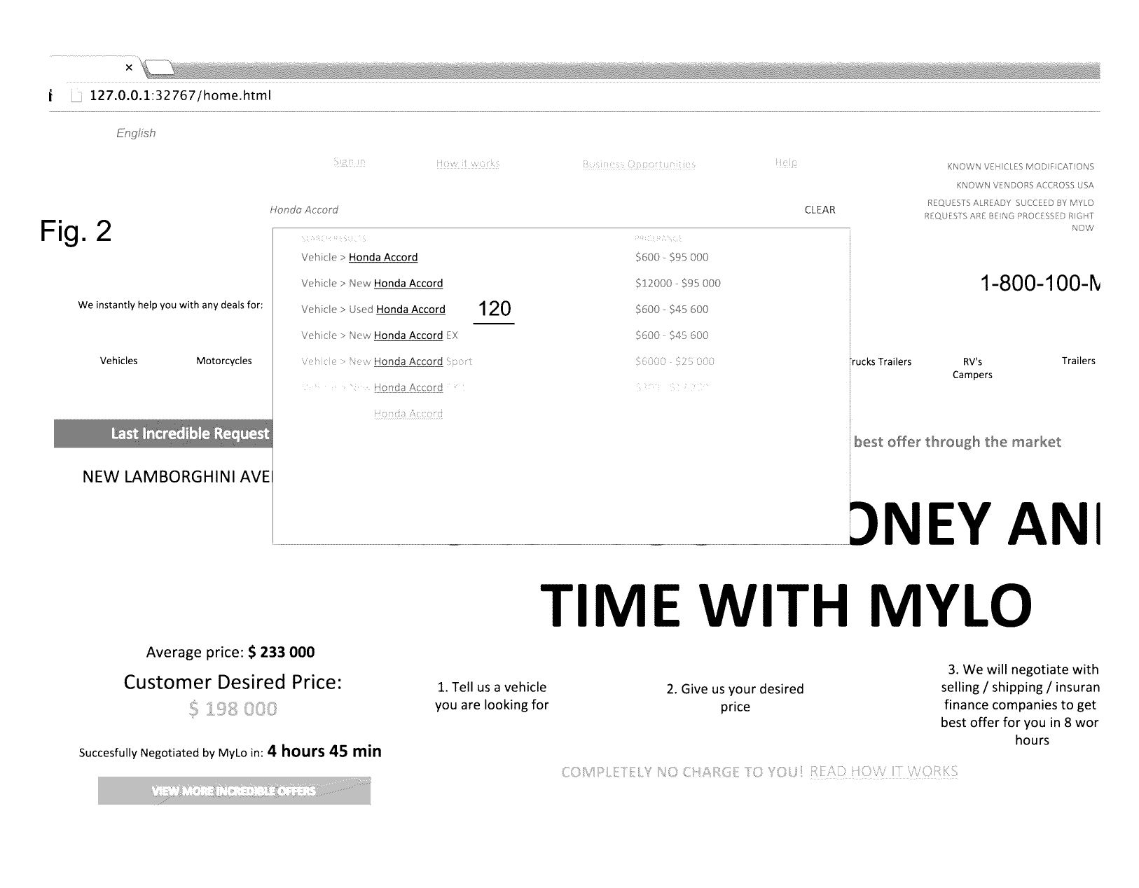

Referring to FIG. 2, a system generated drop down interface 120 depicts product subcategories. The subcategories are triggered by the category or product entered into the first interface 100.

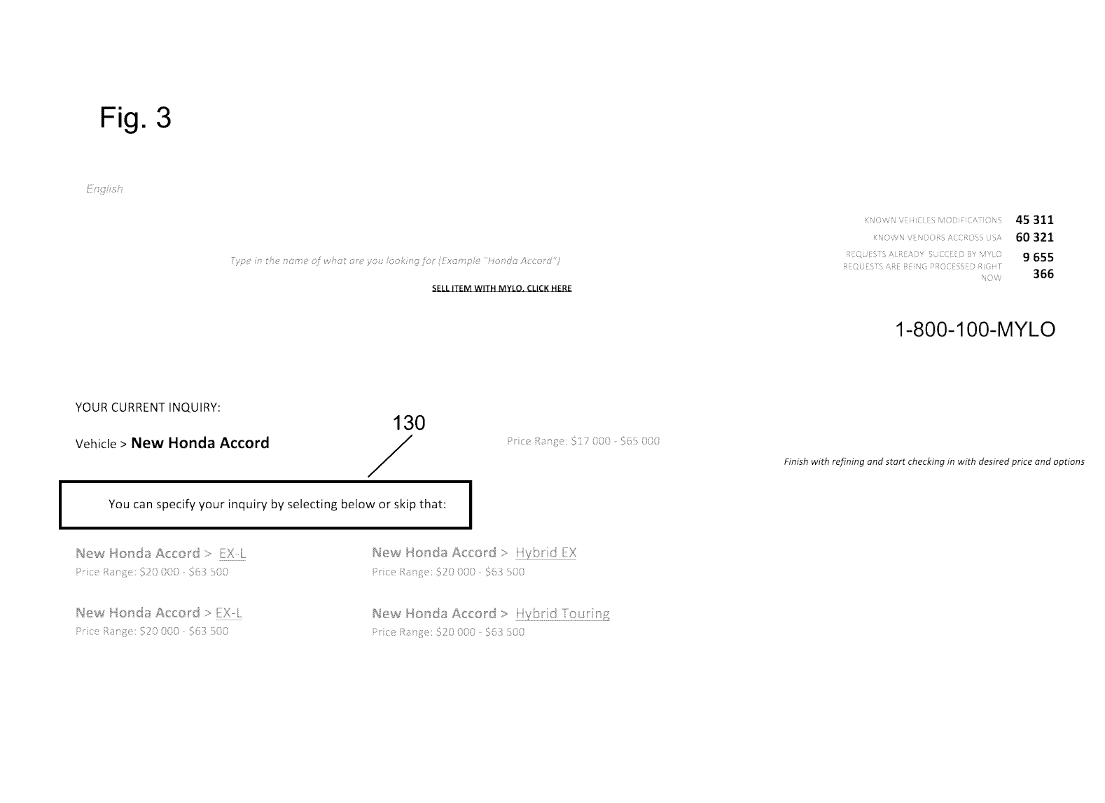

Referring to FIG. 3, a system generated menu offers proposed matches to a user entered product description. Users may be offered an interface or message 130 to select offered products.

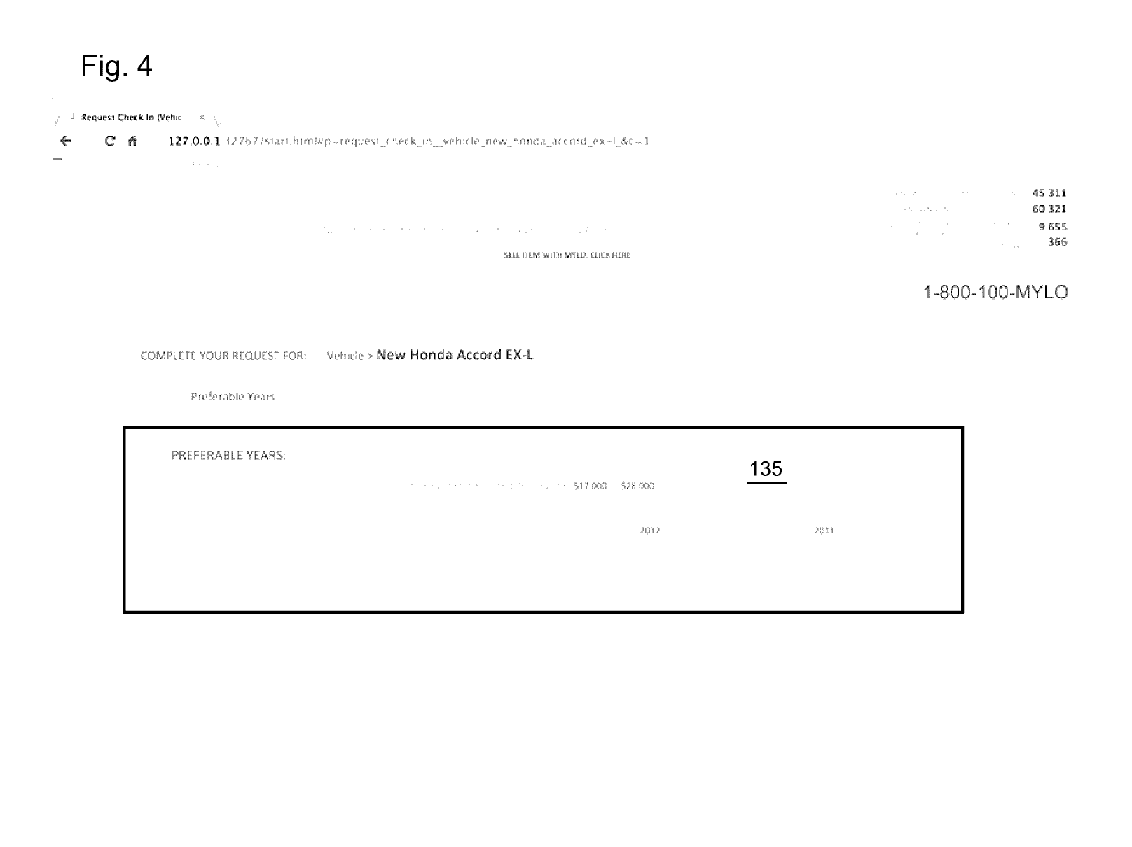

Referring to FIG. 4, a year selection interface 135 is presented.

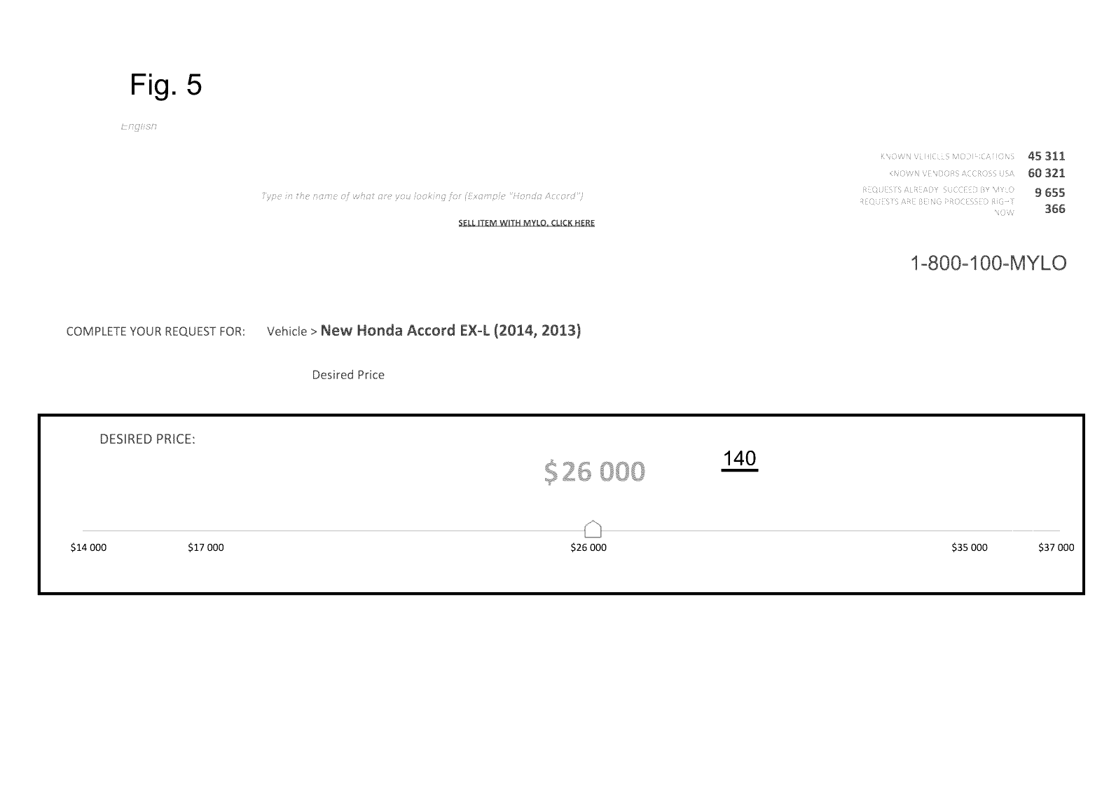

Referring to FIG. 5, a desired price slider interface 140 is presented.

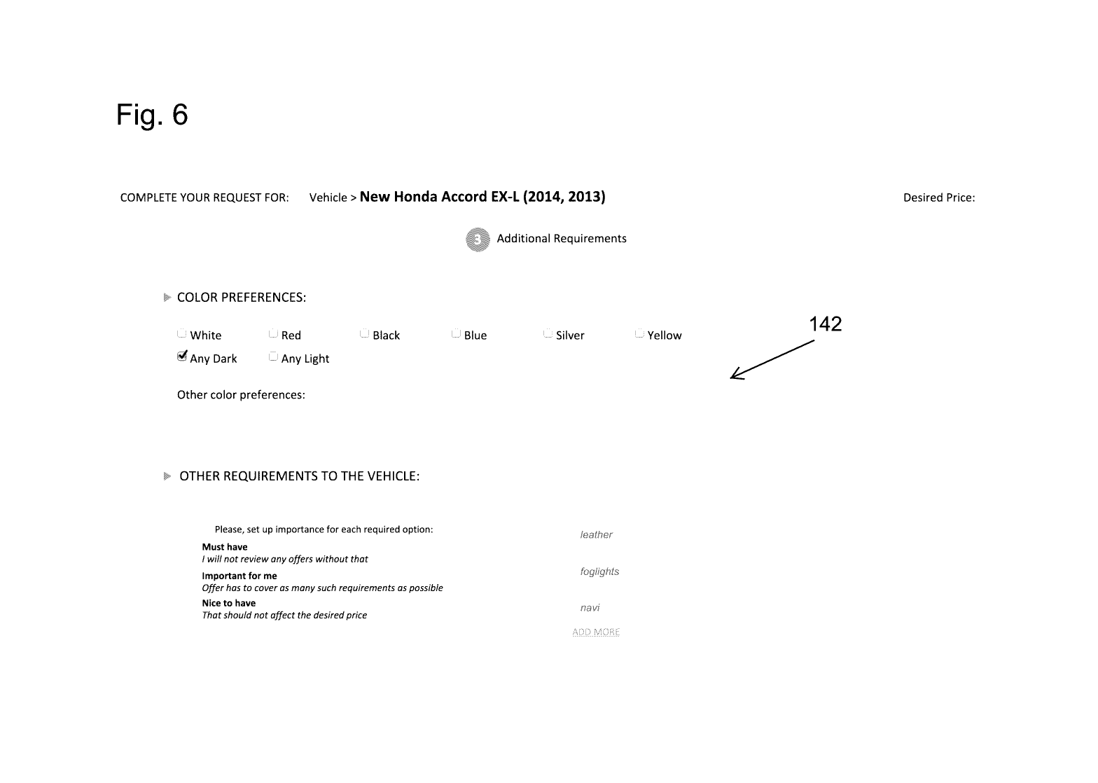

Referring to FIG. 6, an interface to enter additional requirements 142 or additional product features is presented.

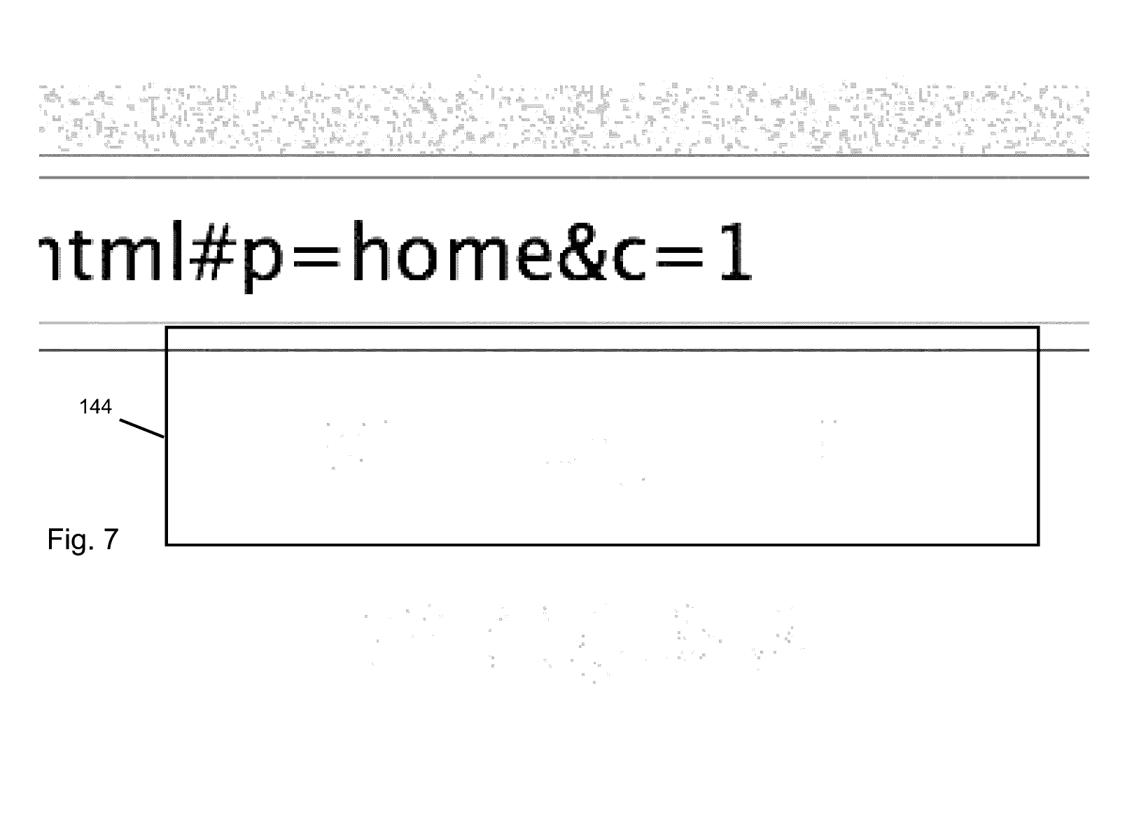

Referring to FIG. 7, an expanded “my requests icon” 144 is presented.

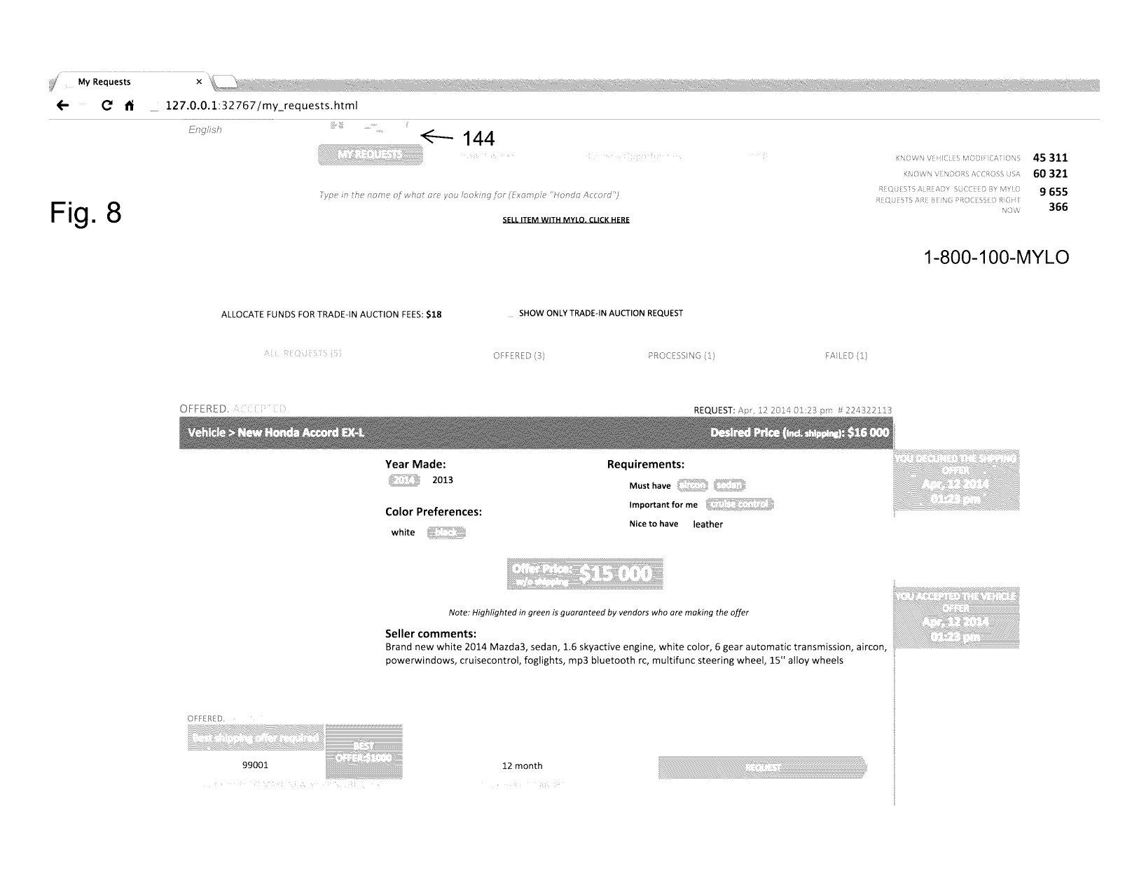

FIG. 8 depicts the “my requests icon” 144 within an offered price interface.

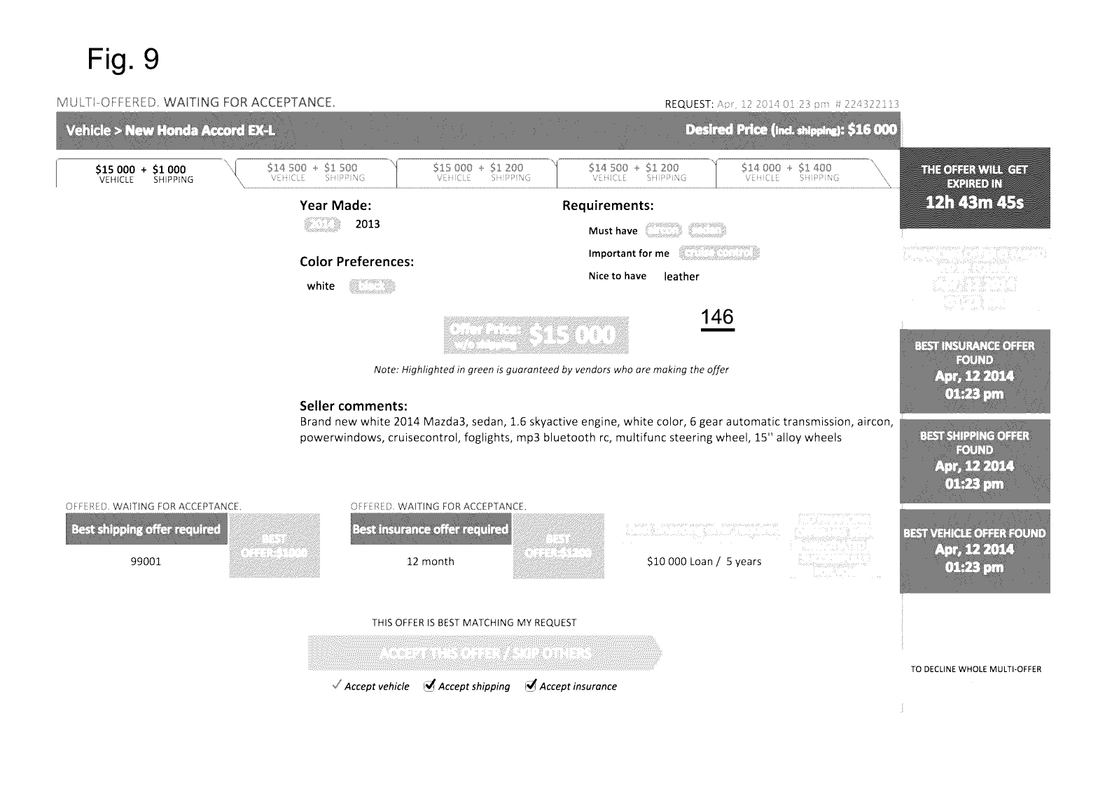

FIG. 9 depicts an offer of sale 146 and a listing of the five best offers.

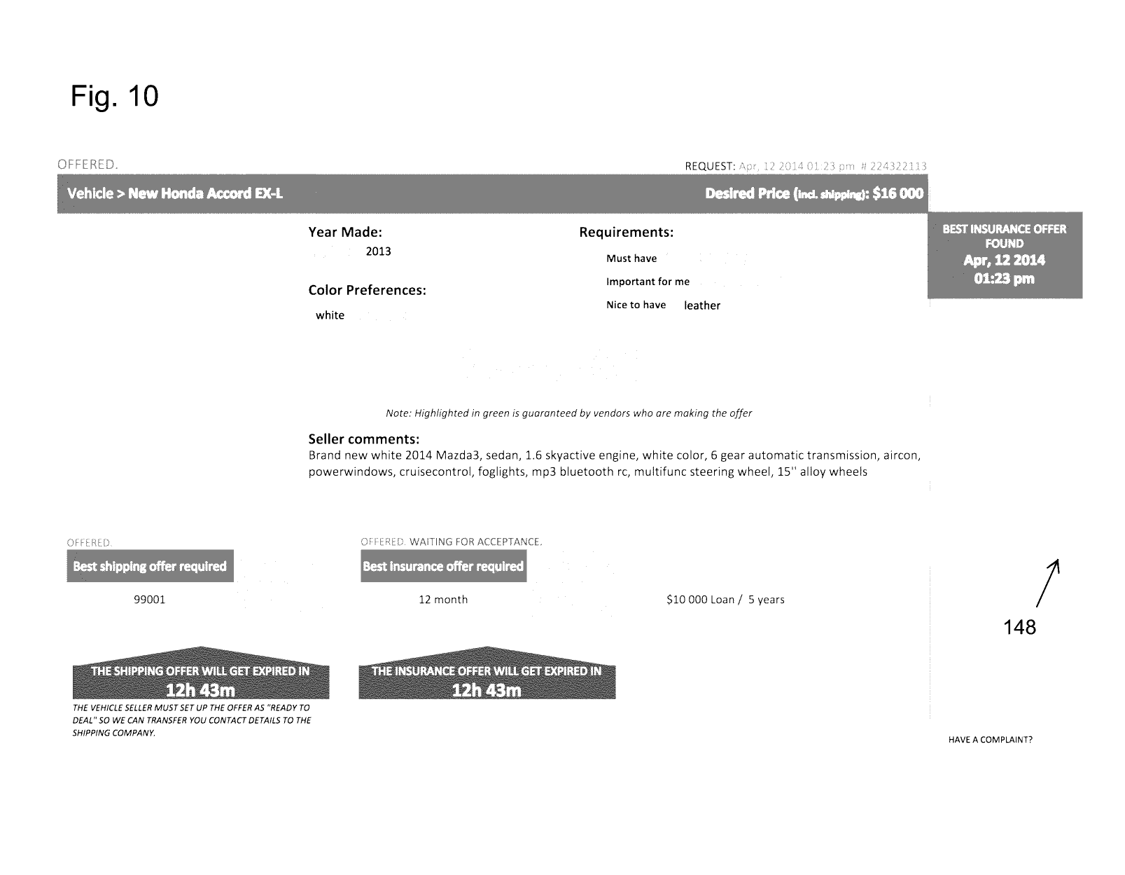

FIG. 10 depicts an interface showing that an offer has been accepted 148. At this juncture, a consumer is waiting to be contacted by the vendor.

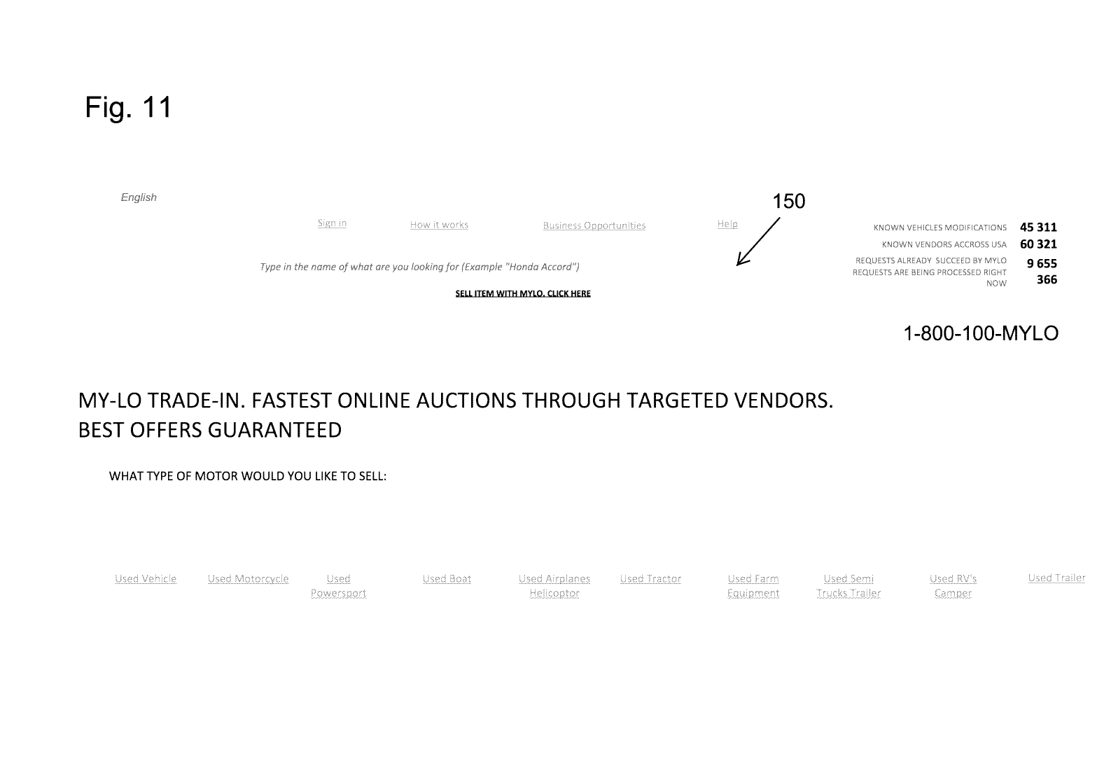

FIG. 11 depicts a data entry point 150 to enter a product to be sold by a consumer. This interface may be considered an opening page for a consumer selling a product. The method of using “targeted vendors” is presented. In a disclosed embodiment vendors are vetted or otherwise selected. Such vendors may have previously expressed an interest in bidding for a type of car or product offered by a consumer using the disclosed system.

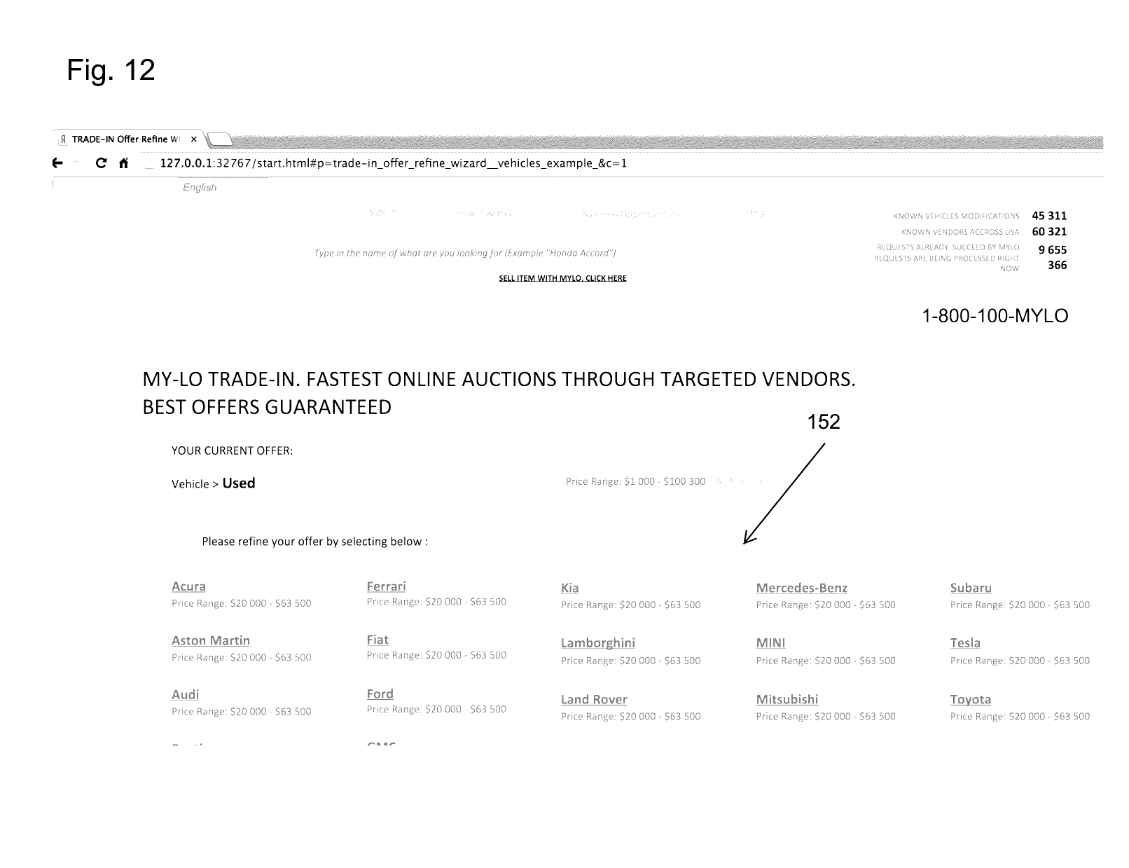

FIG. 12 depicts a selection of product categories or brands 152 wherein a consumer may select the brand of product they are attempting to sell.

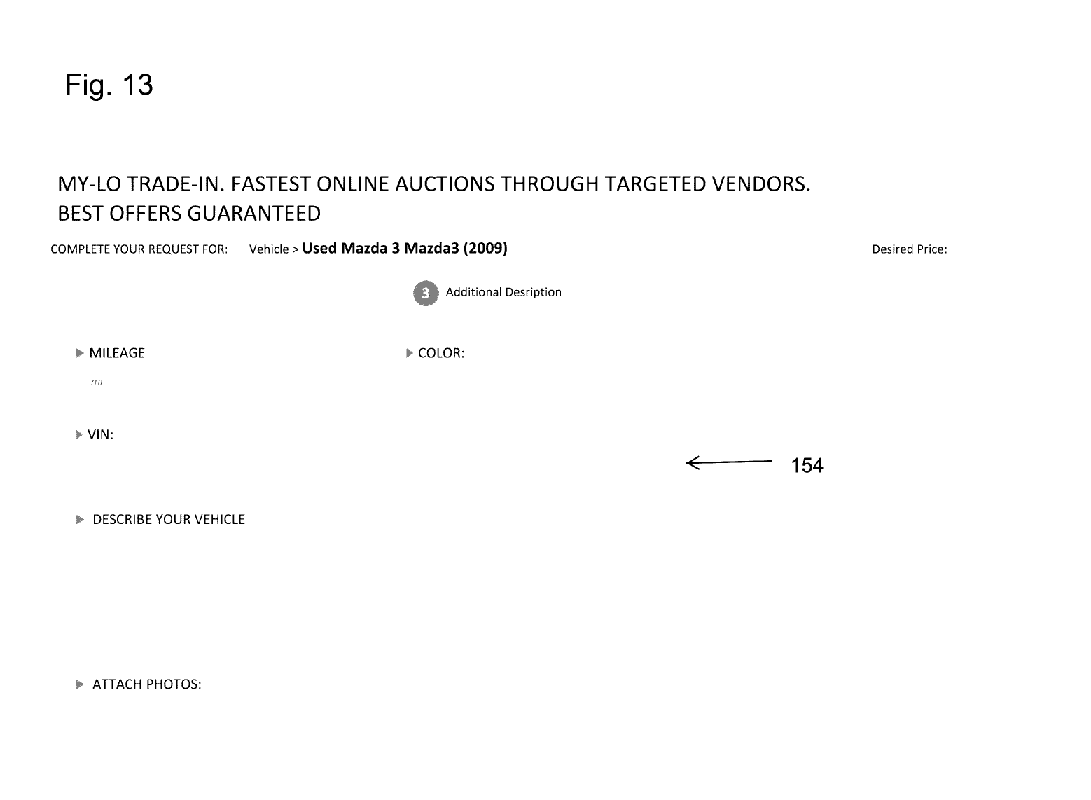

FIG. 13 depicts an additional description interface for product to be sold by a consumer.

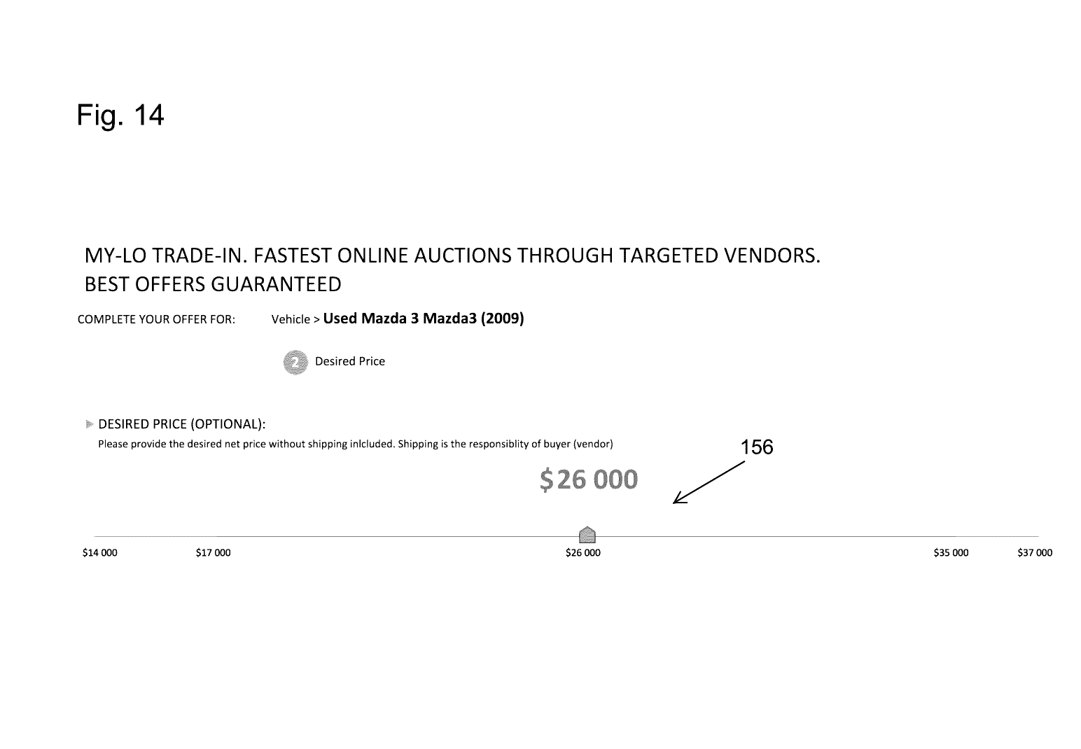

FIG. 14 depicts a slider function 156 to select a desired selling price of product sold by a consumer.

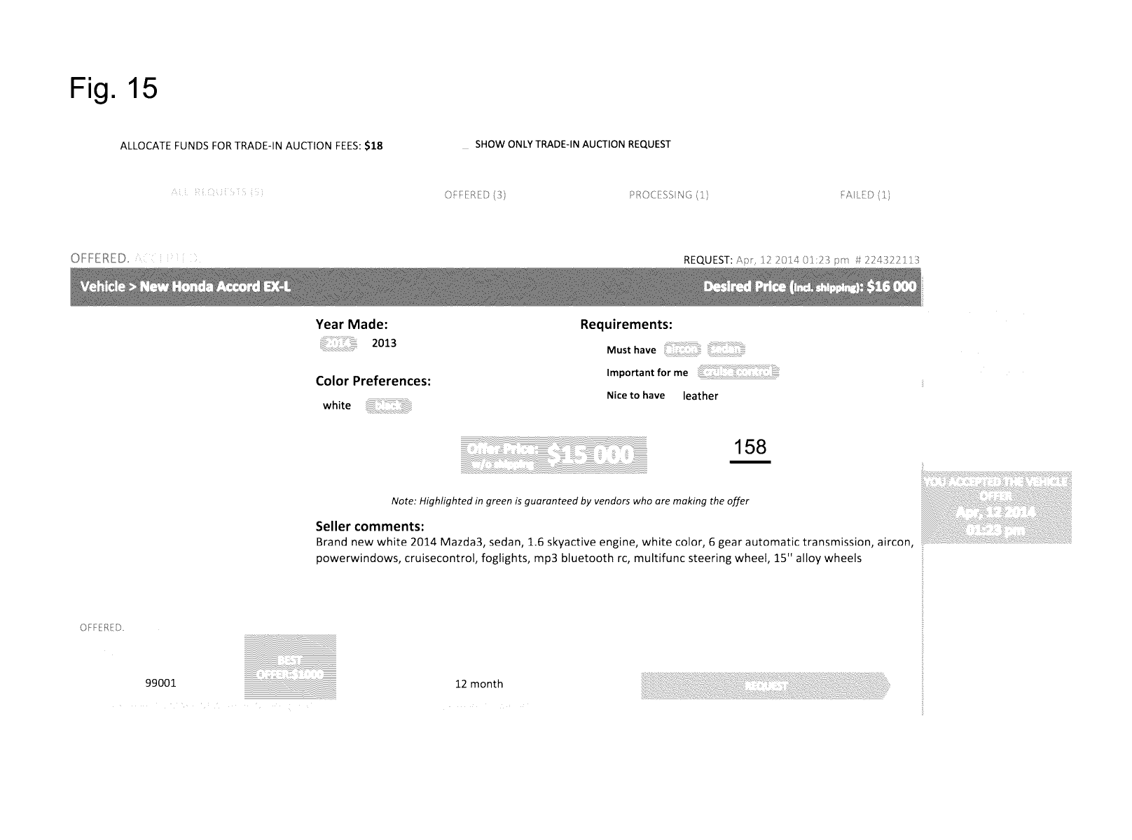

FIG. 15 depicts an interface displaying “observed bids” to purchase a product offered by a consumer or other user of the system.

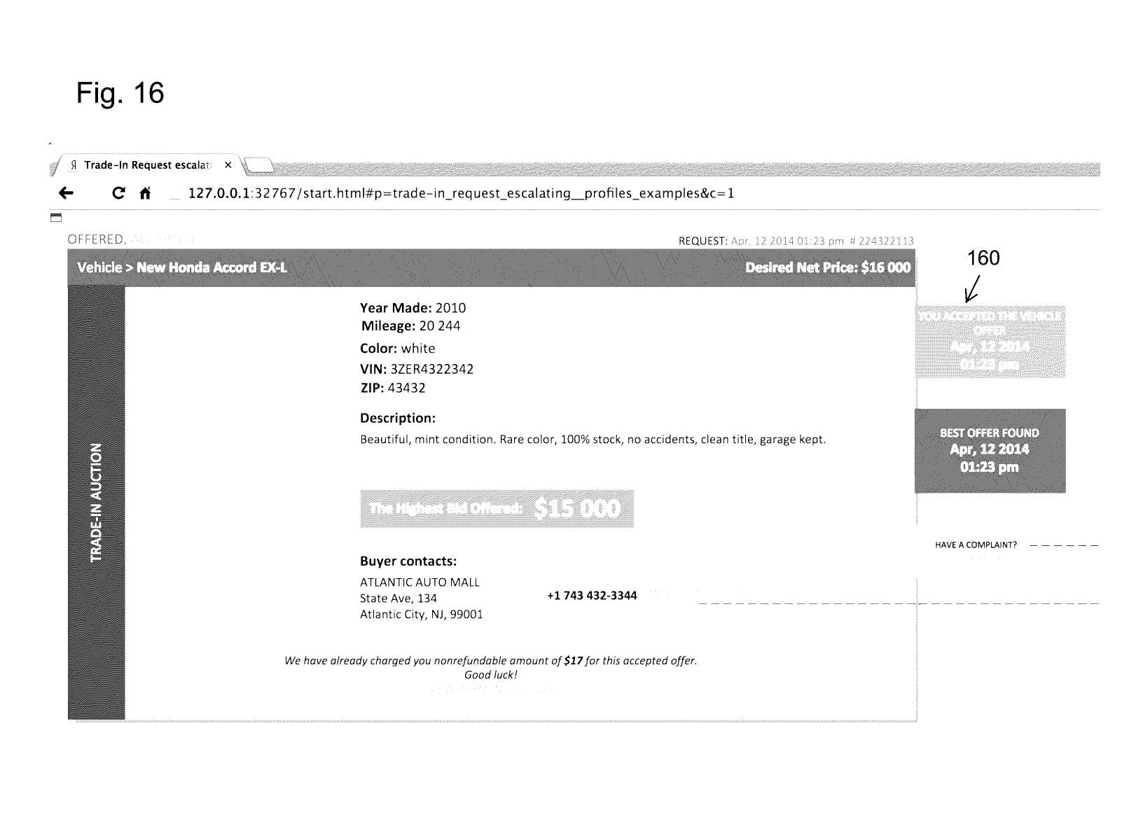

FIG. 16 depicts an interface 160 showing that an offer to purchase was accepted.

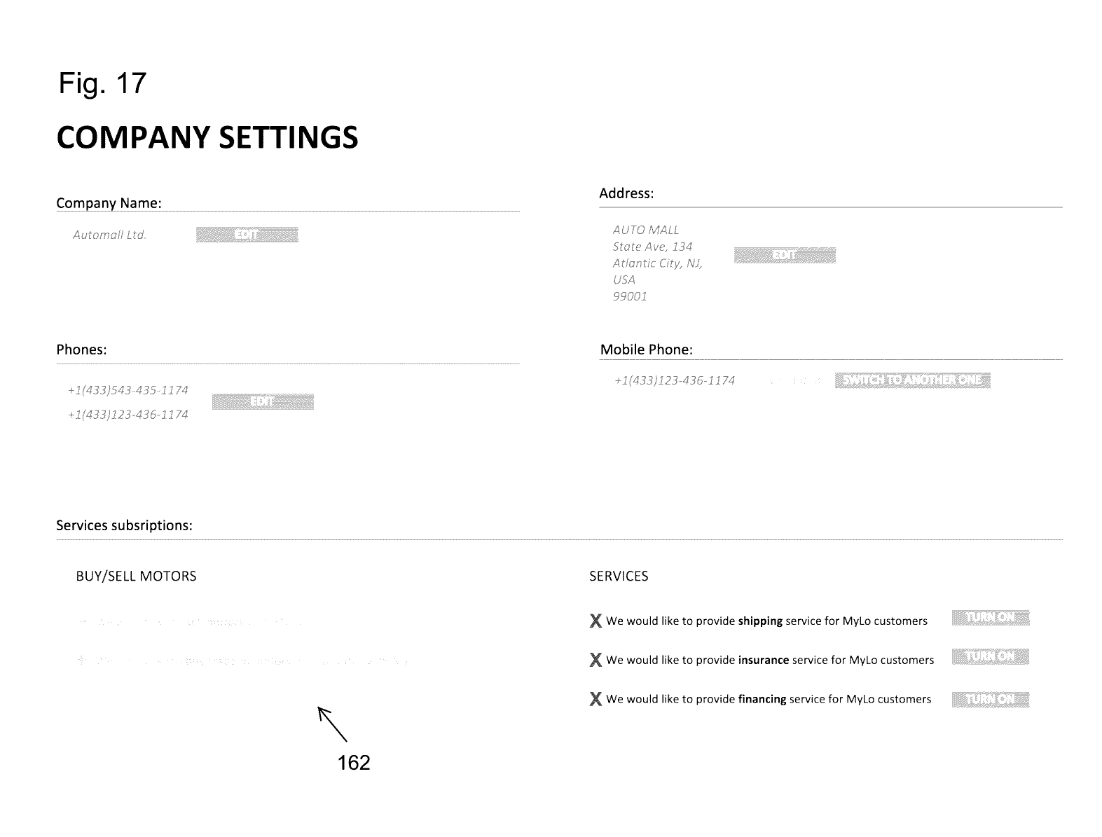

FIG. 17 depicts an interface 162 for vendor or buyer subscriptions. In this “services subscriptions” section a vendor or other system user may indicate preferences for receiving various offers of purchase of sale. In the presented example, a company or vendor may adjust various system settings to customize their interaction with the system.

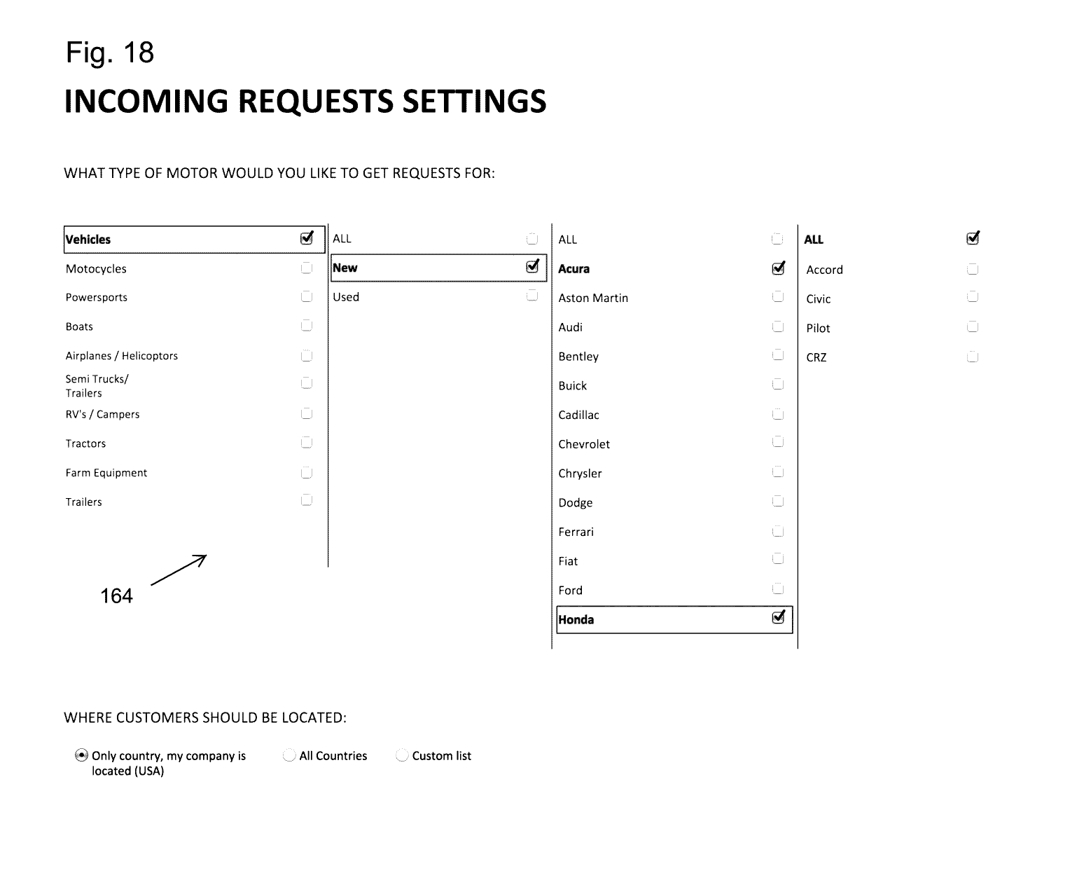

FIG. 18 depicts a selection tree 164 wherein a vendor or other system user may indicate the types of products that they are interested in selling.

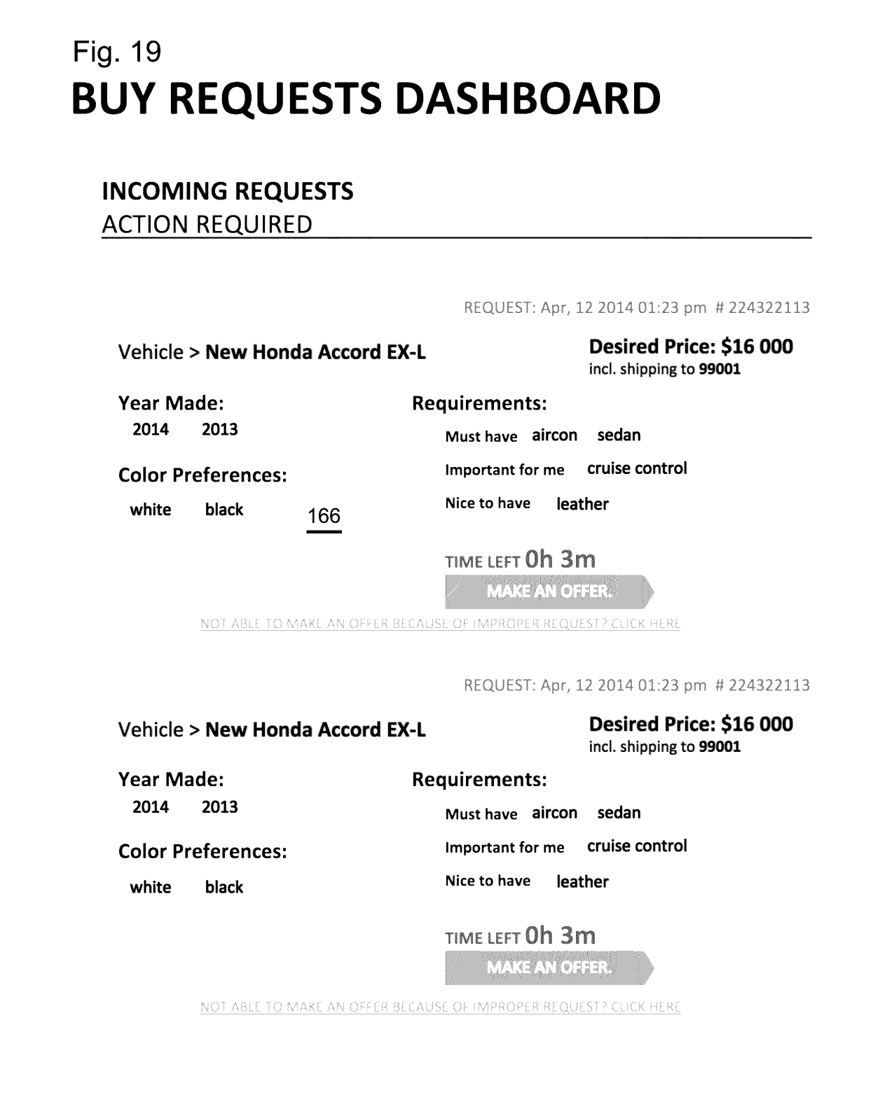

FIG. 19 depicts a “buy request” dashboard 166 wherein a vendor may review requests to purchase various products.

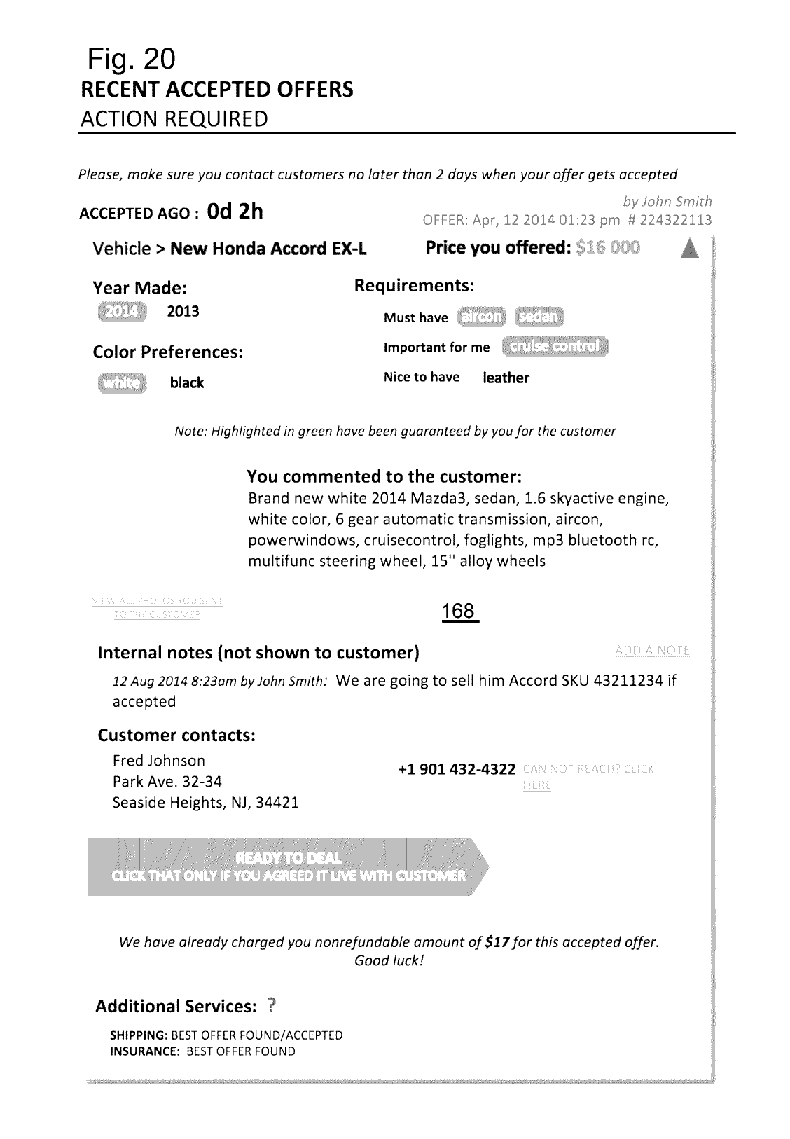

FIG. 20 depicts an interface and display 168 for action required after an offer is accepted. This interface is intended for a vendor registered or enrolled within the system.

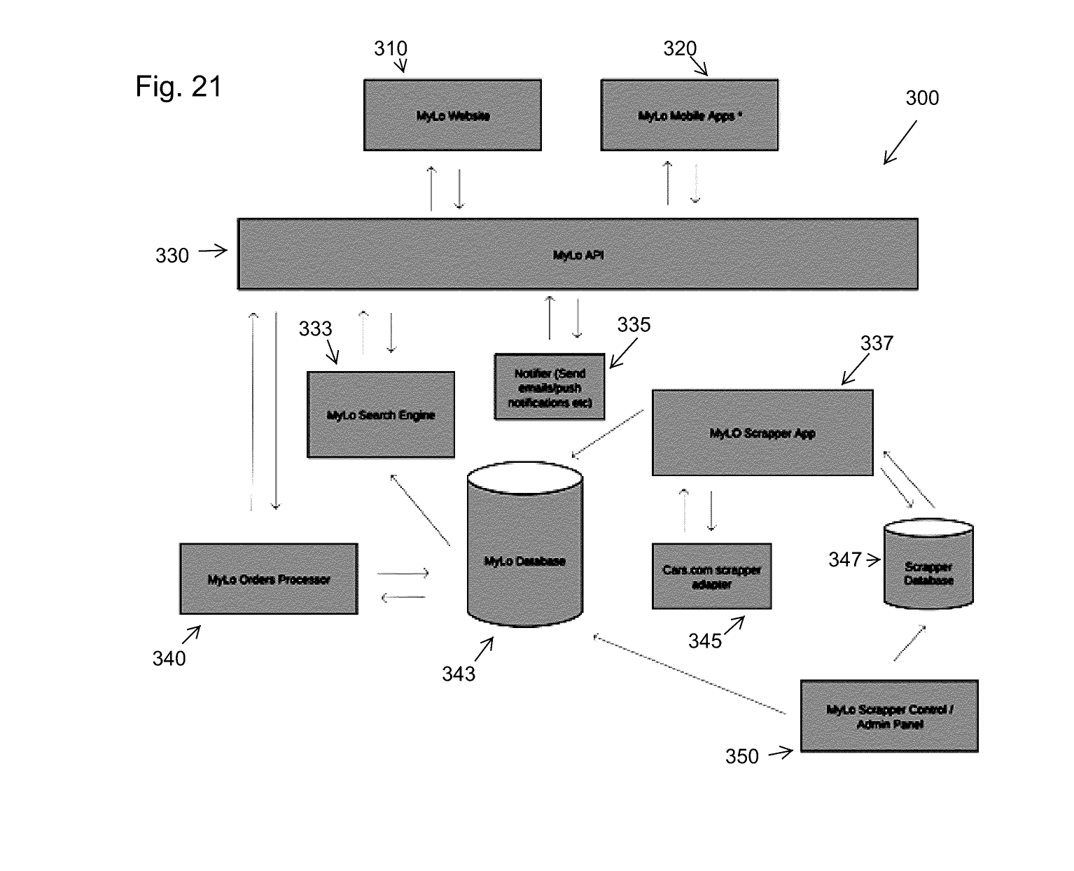

FIG. 21 depicts a schematic view of a disclosed machine implemented system 300 an method wherein a system website 310 or other user interface interacts with an application programing interface 330. Concurrently, system mobile applications 320 may also interact with an application programing interface 330. The application programing interface 330 may interact with a system order processor engine 340, a system search engine 333, a notification engine 335 and other components. The system order processor engine may further interact with a system database 343. The system database 343 may interact with the system search engine 333, scrapper application 337 and scrapper control and administration panel 350. The scrapper application 337 may interact with a cars.com scrapper adaptor 345 and a scrapper database 347.

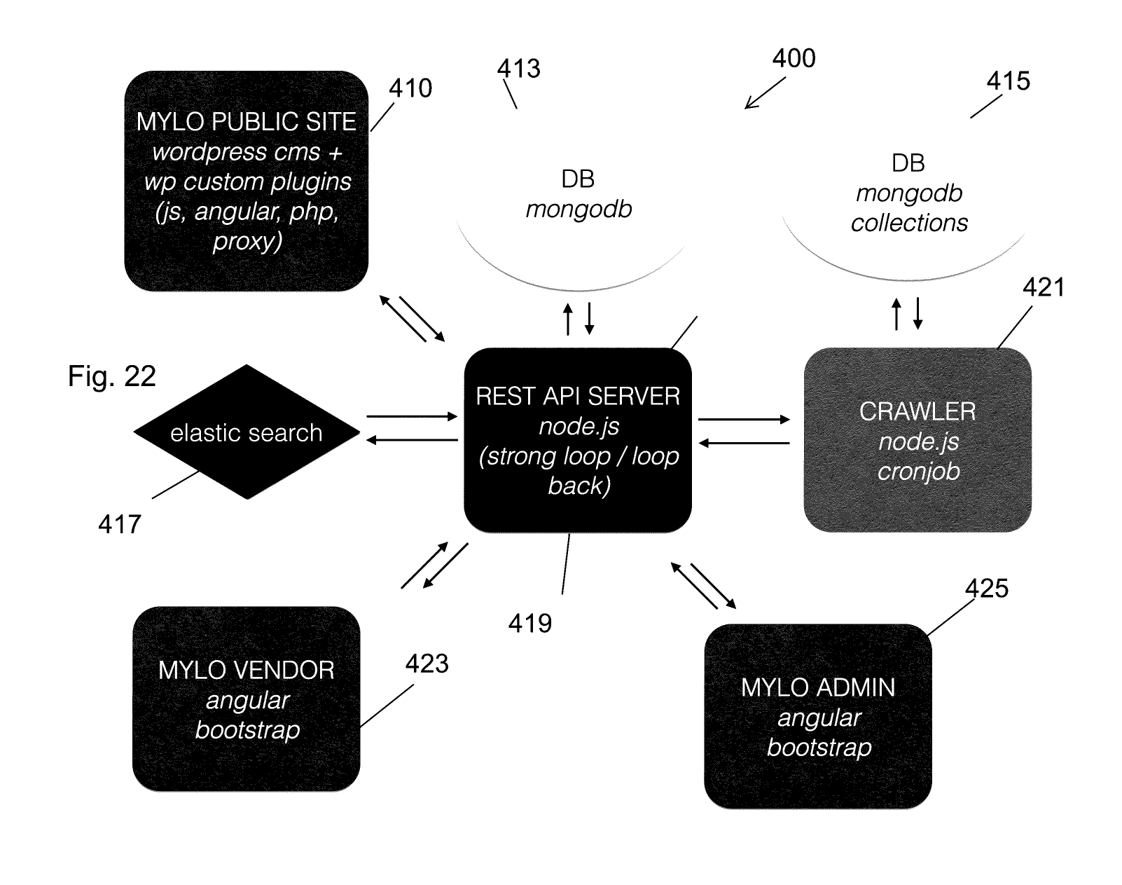

FIG. 22 depicts a schematic view of disclosed system attributes 400 which may include a public website 410, a system of database collection and manipulation 413, a collection of information 415 from a database or plurality of databases, a search system 417, a system of loop search and information deposit or storage 419, a system of search 421, system of search on the vendor side 423 and a system of search on the system side 425.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

Disclosed embodiments may include the following items.

Items

1. A machine implemented system of collecting and transmitting purchase inquiries from consumers to a plurality of vendors, collecting vendor offers and transmitting vendor offers to consumers, the system comprising:

a) a processor, non-volatile memory, machine readable media and machine readable instructions upon the machine readable media, the machine readable instructions stored within the non-volatile memory and read by the processor, the processor in communication with a server system, the server system generating a website 310;

b) the website 310 in communication with an application programing interface 330;

c) the application programing interface 330 in communication with a system of mobile applications 320, system search engine 333, notification engine 335 and system order processor engine 340;

d) a database system 343 in communication with the system order processor engine 340, the system search engine 333, a system scrapper collection application 337 and a system control and administration panel for system scraper 350;

e) a scraper database 347 in communication with the system control and administration panel for system scraper 350 and the system scraper collection application 337;

f) the website comprising a consumer interface 100 accepting input of a product to be purchased and transmitting the input to the application programing interface 330, wherein the input is subsequently transmitted to the system search engine 333 and database system 343;

g) the input further transmitted to a plurality of vendors, the plurality of vendors presented with a vendor interface generated by the website the vendor interface accepting vendor generated data and transmitting the vendor generated data to the consumer interface.

2. The system of 1 wherein the system scrapper collection application 337 and scrapper database locate vendors selling products matching the product entered into the consumer interface.

What is claimed is:

1. A machine implemented system of collecting and transmitting purchase inquiries from consumers to a plurality of vendors, collecting vendor offers and transmitting vendor offers to consumers, the system comprising:
a) a processor, non-volatile memory, machine readable media and machine readable instructions upon the machine readable media, the machine readable instructions stored within the non-volatile memory and read by the processor, the processor in communication with a server system, the server system generating a website;
b) the website in communication with an application programing interface;
c) the application programing interface in communication with a system of mobile applications, system search engine, notification engine and system order processor engine;
d) a database system in communication with the system order processor engine, the system search engine, a system scrapper collection application and a system control and administration panel for system scraper;
e) a scraper database in communication with the system control and administration panel for system scraper and the system scraper collection application;
f) the website comprising a consumer interface accepting input of a product to be purchased and transmitting the input to the application programing interface, wherein the input is subsequently transmitted to the system search engine and database system;
g) the input further transmitted to a plurality of vendors, the plurality of vendors presented with a vendor interface generated by the website the vendor interface accepting vendor generated data and transmitting the vendor generated data to the consumer interface.

2. The system of claim 1 wherein the system scrapper collection application and scrapper database locate vendors selling products matching the product entered into the consumer interface.
